(19) United States
(12) Patent Application Publication
(10) Pub. No.: US 2007/0164919 A1
(43) Pub. Date: Jul. 19, 2007

(54) WIDEBAND CHIP ANTENNA

(75) Inventors: Jae Chan Lee, Suwon (KR); Hyun Hak Kim, Osan (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/565,488

(22) Filed: Nov. 30, 2006

(30) Foreign Application Priority Data
Jan. 16, 2006 (KR) 10-2006-0004600

(51) Int. Cl. H01Q 13/10

(52) U.S. Cl. 343/770; 343/767

(57) ABSTRACT

Provided a wideband chip antenna in which the outer surface of a dielectric or magnetic body block is surrounded by a conductor. The wideband chip antenna comprises one or more slots or slits that are formed on the top surface of the wideband chip antenna and of which predetermined portions are opened; one or more slits that are formed on the bottom surface of the wideband chip antenna and of which predetermined portions are opened; and one or more windows that are formed on one or more side surfaces of the wideband chip antenna by opening predetermined portions thereof. The wideband chip antenna can simultaneously transmit and receive signals at various bands, and the size thereof can be reduced. Further, the resonance property of the antenna can be easily adjusted, and a wider bandwidth can be secured.

### CROSS-REFERENCE TO RELATED APPLICATIONS

This application claims the benefit of Korean Patent Application No. 10-2006-0004600 filed with the Korea Industrial Property Office on Jan. 16, 2006, the disclosure of which is incorporated herein by reference.

### BACKGROUND OF THE INVENTION

1. Field of the Invention

The present invention relates to a wideband chip antenna. The wideband chip antenna has a slot or slit formed on the top surface thereof, a slit formed on the bottom surface, and a window formed on the side surface thereof. Therefore, the size of the wideband chip antenna can be reduced. Further, the wideband chip antenna can simultaneously transmit and receive signals at various bands and can easily adjust a resonance property of the antenna, thereby securing a wider bandwidth.

2. Description of the Related Art

Recently, as the mobile communication technology develops, various functions are added to a small terminal so as to provide a variety of terminal services desired by customers. Accordingly, a wide communication bandwidth and multi-communication channels are increasingly required to be secured.

Therefore, a plurality of antennas need to be built in wireless communication equipments, which makes it difficult to design wireless communication equipments. Further, the sizes of wireless communication equipments become larger, thereby increasing a manufacturing cost. Although a log periodic antenna can be applied as a solution, the log periodic antenna becomes composed of a plurality of elements, which means the size thereof is inevitably large.

FIG. 1 is a diagram illustrating a basic structure of a conventional slot antenna, and FIG. 2 is a diagram showing electric field distribution which is formed by electric and magnetic field energy supplied to a slot of FIG. 1.

As shown in FIG. 1, the slot antenna has a slot 12 formed on one surface and a microstrip feeder (not shown) formed on the other surface by reference to a dielectric substrate 11 having an arbitrary dielectric constant and thickness. The slot 12 is formed to have a predetermined length for the radiation of electric and magnetic field, and the microstrip feeder feeds electric and magnetic field energy to the slot 12.

As shown in FIG. 2, the electric and magnetic field radiates into a free space through the formed electric field. Although such a slot antenna shows a relatively wide frequency bandwidth characteristic, a slot having a length of predetermined wavelength (for example, λ/2 if a center frequency wavelength is λ) should be formed.

Therefore, in order to reduce the size of the conventional slot antenna, the structure of a meandered slot antenna is used in which the slot is formed so as to be bent horizontally.

FIG. 3 is a basic structure of a conventional meandered slot antenna, and FIG. 4 is a diagram showing electric field distribution which is formed by electric and magnetic field energy supplied to a slot of FIG. 3.

As shown in FIG. 3, the slot antenna has a slot 32 formed on one surface and a microstrip feeder (not shown) formed on the other surface by reference to a dielectric substrate 31. The microstrip feeder feeds electric and magnetic field energy to the slot 32. The slot 32 is formed on one surface of the dielectric substrate 31 in a horizontal direction and is bent in an S-shape.

When a center frequency wavelength of the meandered slot antenna of FIG. 3 is λ, the slot antenna has a length of λ/2. Further, the length thereof gradually decreases in accordance with how many times the slot is bent.

At this time, as the slot 32 with a meandered structure is formed, the electric field distribution of the slot antenna is formed as shown in FIG. 4

However, the above-described slot antenna of FIG. 1 should have a slot formed thereon, the slot having a length of predetermined wavelength. Therefore, the size thereof increases as a whole.

Further, in the above-described slot antenna of FIG. 2, as the slot 32 with a meandered structure is formed as shown in FIG. 4, ‘a’ electric field components and ‘b’ electric field components are formed in a reverse direction so as to be offset. Therefore, radiated electric and magnetic energy is reduced.

Therefore, as an index representing a characteristic of an antenna together with a frequency bandwidth, a gain and radiation efficiency defined by the following expressions (1) and (2), respectively, decrease.

Gain=4π(radiation intensity/antenna input power) (1)

Radiation efficiency=(radiation intensity/antenna input power) (2)

In this case, a gain and radiation efficiency of an antenna are indexes representing the magnitude of radiating energy excluding energy which is lost as a loss caused by a dielectric body or conductor of the antenna or is lost as reactance components around the antenna with respect to input power. The higher a gain and radiation efficiency are, the more energy can be radiated through an antenna.

### SUMMARY OF THE INVENTION

An advantage of the present invention is that it provides a wideband chip antenna, in which a slot or slit is formed on the top surface thereof, and simultaneously, a slit is formed on the bottom surface. Therefore, the size of the wideband chip antenna can be reduced. Further, the wideband chip antenna can simultaneously transmit and receive signals at various bands.

Another advantage of the invention is that it provides a wideband chip antenna in which the widths of slot and slit are adjusted so that a resonance characteristic of the antenna can be easily adjusted, thereby enhancing an antenna gain and radiation efficiency.

A further advantage of the invention is that it provides a wideband chip antenna in which windows are formed on the side surfaces thereof such that a wider bandwidth can be secured.

Additional aspect and advantages of the present general inventive concept will be set forth in part in the description which follows and, in part, will be obvious from the description, or may be learned by practice of the general inventive concept.

According to an aspect of the invention, a wideband chip antenna in which the outer surface of a dielectric or magnetic body block is surrounded by a conductor. The wideband chip antenna comprises one or more slots or slits that are formed on the top surface of the wideband chip antenna and of which predetermined portions are opened; one or more slits that are formed on the bottom surface of the wideband chip antenna and of which predetermined portions are opened; and one or more windows that are formed on one or more side surfaces of the wideband chip antenna by opening predetermined portions thereof.

According to another aspect of the invention, the width of the slot is adjusted so as to have a predetermined value.

According to a further aspect of the invention, the width of the slit formed on the top surface is adjusted so as to have a predetermined value.

According to a still further aspect of the invention, the width of the slit formed on the bottom surface is adjusted so as to have a predetermined value.

According to a still further aspect of the invention, a one-side width of the slot is adjusted so as to be larger than the other side width of thereof.

According to a still further aspect of the invention, a one-side width of the slit formed on the top surface is adjusted so as to be larger than the other side width of thereof.

According to a still further aspect of the invention, a one-side width of the slit formed on the bottom surface is adjusted so as to be larger than the other side width of thereof.

According to a still further aspect of the invention, the one-side width of the slot is adjusted so that the slot has an isosceles trapezoid shape where a one-side width is larger than the other side width.

According to a still further aspect of the invention, the one-side width of the slit formed on the top surface is adjusted so that the slit has an isosceles trapezoid shape where a one-side width is larger than the other side width.

According to a still further aspect of the invention, the one-side width of the slit formed on the bottom surface is adjusted so that the slit has an isosceles trapezoid shape where a one-side width is larger than the other side width.

According to a still further aspect of the invention, the one-side width of the slot is adjusted so that the slot has a semi-elliptical shape where a one-side width is larger than the other side width.

According to a still further aspect of the invention, the one-side width of the slit formed on the top surface is adjusted so that the slit has a semi-elliptical shape where a one-side width is larger than the other side width.

According to a still further aspect of the invention, the one-side width of the slit formed on the bottom surface is adjusted so that the slit has a semi-elliptical shape where a one-side width is larger than the other side width.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating a basic structure of a conventional slot antenna;

FIG. 2 is a diagram showing electric field distribution which is formed by electromagnetic field energy supplied to a slot of FIG. 1;

FIG. 3 is a diagram illustrating a basic structure of a conventional meandered slot antenna;

FIG. 4 is a diagram showing electric field distribution which is formed by electric and magnetic field energy supplied to a slot of FIG. 3;

FIGS. 5 and 6 are diagrams illustrating the structure of a wideband chip antenna according to a first embodiment of the present invention, FIG. 5 illustrating a wideband chip antenna having a slot formed on the top surface thereof and FIG. 6 illustrating wideband chip antenna having a slit formed on the bottom surface thereof;

FIGS. 7 and 8 are diagrams illustrating the structure of a wideband chip antenna according to a second embodiment of the present invention, the wideband chip antenna having a slot formed on the top surface thereof;

FIGS. 9 and 10 are diagrams illustrating the structure of a wideband chip antenna according to the second embodiment having a slit formed on the top surface;

FIGS. 11 and 12 are graphs showing an experiment result of the wideband chip antenna according to the invention, FIG. 11 showing an experiment result when a slot or slit is formed on the top surface, and simultaneously, a slit is formed on the bottom surface and FIG. 12 comparatively showing experiment results when windows are not formed and when windows are formed.

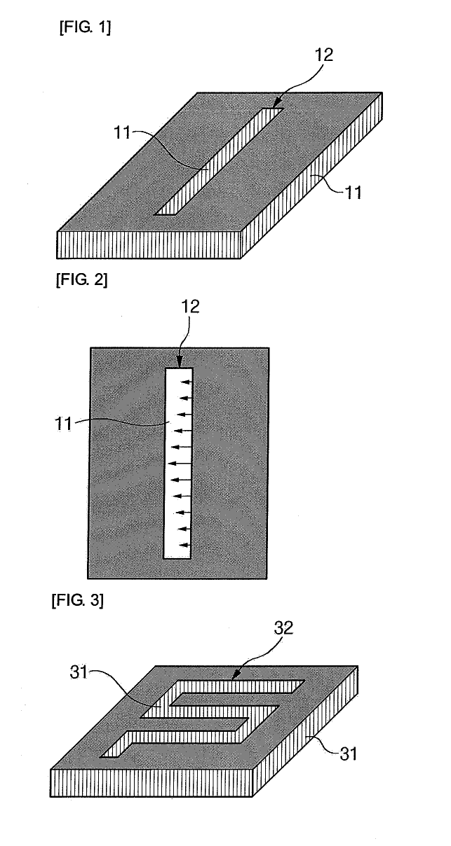

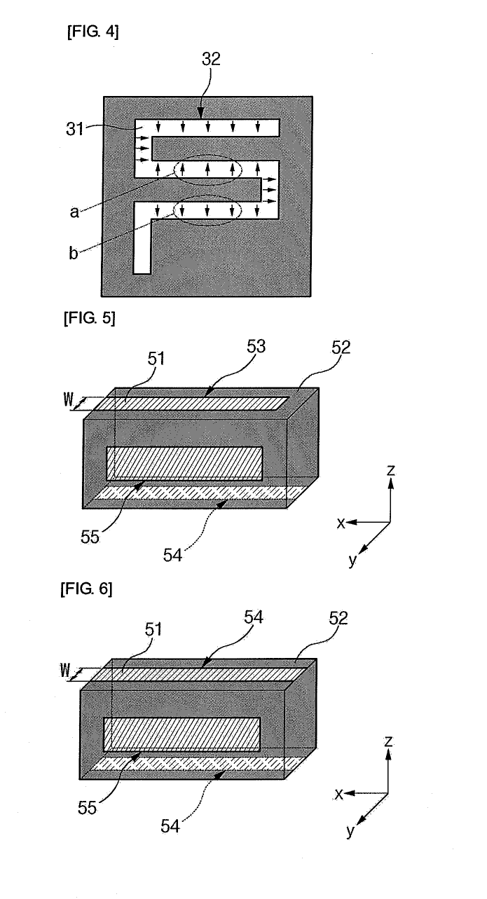

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, preferred embodiments of the present invention will be described in detail with reference to the accompanying drawings.

### First Embodiment

FIGS. 5 and 6 are diagrams illustrating the structure of a wideband chip antenna according to a first embodiment of the invention. FIG. 5 is a diagram illustrating the structure of a wideband chip antenna having a slot formed on the top surface thereof, and FIG. 6 is a diagram illustrating the structure of a wideband chip antenna having a slit formed on the top surface thereof.

As shown in FIGS. 5 and 6, the wideband chip antenna according to the invention is a wideband chip antenna in which the outer surface of a dielectric body or magnetic body block 51 is surrounded by a conductor 52. The wideband chip antenna has one or more slots 53 or slits 54 formed on the top surface thereof, a slit 54 formed on the bottom surface, and one or more windows 55 formed on the side surface.

Predetermined portions of the slots 53 and silts 54 of the first embodiment are opened. Further, the slots 53 and slits 54 are formed to have such a predetermined width W that can be easily adjusted.

The windows 55 of the first embodiment are formed by opening predetermined portions of one or more side surfaces.

### Second Embodiment

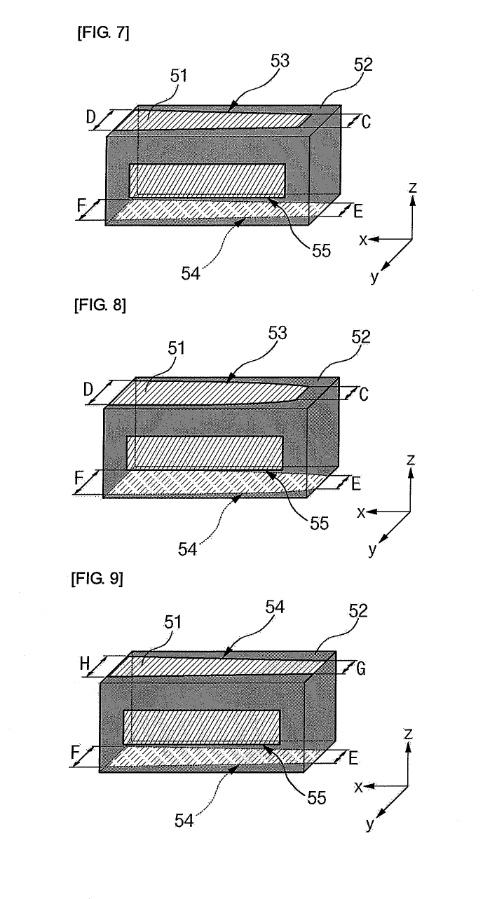

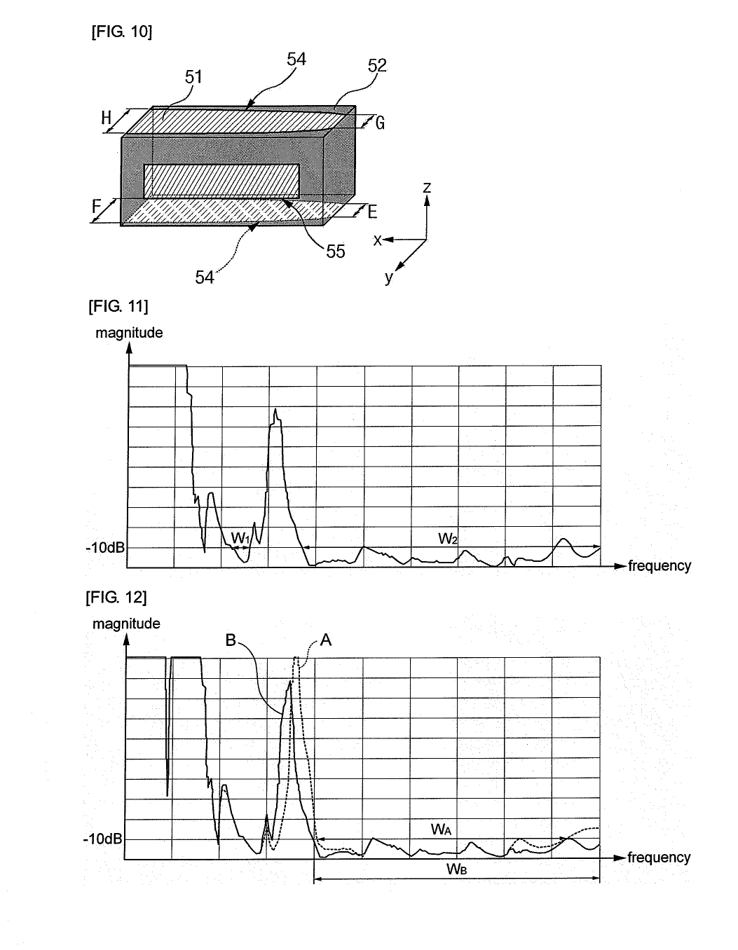

FIGS. 7 to 10 are diagrams illustrating the structure of a wideband chip antenna according to a second embodiment of the invention. FIGS. 7 and 8 are diagrams illustrating the structure of a wideband chip antenna having a slot formed on the top surface thereof, and FIGS. 9 and 10 are diagrams illustrating the structure of a wideband chip antenna having a slit formed on the top surface thereof.

As shown in FIGS. 7 to 10, a one-side width D of the slot 53 formed on the top surface can be adjusted so as to be larger than the other side width C thereof, and one-side width H or F of the slit 54 formed on the top or bottom surface can be adjusted so as to be larger than the other side width G or E thereof.

When the slot 53 is formed on the top surface as shown in FIGS. 7 and 8, the slot 53 can be formed in an isosceles trapezoid shape or semi-elliptical shape where a one-side width D of the slot 53 is larger than the other side width C thereof. Further, the one-side width D of the slot 53 can be easily adjusted.

The slit 54 formed on the bottom surface can also have an isosceles trapezoid shape or semi-elliptical shape where a one-side width F of the slit 54 is larger than the other side width E thereof. Further, the one-side width F of the slit 54 can be easily adjusted, similar to the slot 53 formed on the top surface.

When the slit 54 is formed on the top surface as shown in FIGS. 9 and 10, the slit 54 can be formed in an isosceles trapezoid shape or semi-elliptical shape where a one-side width H of the slit 54 is larger than the other side width G thereof. Further, the one-side width h of the slit 54 can be easily adjusted, similar to the slot shown in FIGS. 7 and 8.

The slit 54 formed on the bottom surface can also have an isosceles trapezoid shape or semi-elliptical shape where a one-side width F of the slit 54 is larger than the other side width E thereof, similar to the slit formed on the bottom surface as shown in FIGS. 7 and 8. Further, the one-side width F of the slit 54 can be easily adjusted.

As such, the wideband chip antenna according the second embodiment, having the slot 53 or slit 54 of which the one-side width is larger than the other side width, can gradually change capacitance between the dielectric or magnetic body 51 and the conductor 52 such that impedance matching can be achieved. Accordingly, loss at the time of transmission and reception can be reduced. Then, the radiation intensity and radiation power described in the expressions (1) and (2) are increased, thereby enhancing a gain and radiation efficiency of the antenna.

The windows 55 of the second embodiment are formed by opening predetermined portions of one or more side surfaces, similar to the first embodiment.

In the above-described wideband chip antennas according to the first and second embodiments, the widths of the slot 53 and silt 54 can be easily adjusted so that a desired antenna resonance property can be achieved.

Further, the slot 53 or slit 54 is formed on the top surface, and simultaneously, the slit 54 is formed on the bottom surface. Therefore, the size of the antenna can be reduced, compared with that of a conventional antenna having a slot or slit formed on only one surface. Further, signals can be simultaneously transmitted and received at various bands.

Further, the wideband chip antennas have the windows 55 formed on one or more side surfaces thereof, thereby securing a wider bandwidth.

FIGS. 11 and 12 are graphs illustrating an experiment result of the wideband chip antenna according to the invention. FIG. 11 is a graph illustrating an experiment result when the slot or slit is formed on the top surface, and simultaneously, the slit is formed on the bottom surface. FIG. 12 is a graph comparatively illustrating experiment results when the window is not formed (A) and when the window is formed (B).

As shown in FIG. 11, it can be found that the wideband chip antennas according to the first and second embodiments can transmit and receive signals at various bands (W₁ and W₂) at the same time, because the slot or slit is formed on the top surface, and simultaneously, the slit is formed on the bottom surface.

Accordingly, the wideband chip antennas according to the first and second embodiments can be simultaneously applied to such systems as GPS (1.5 GHz band), Bluetooth (2.4 GHz band), a wireless LAN, an ultra wide band (UWB; 3-10 GHz) and the like, by reference to a voltage standing wave ratio (VSWR) of 2.5.

As shown in FIG. 12, the wideband chip antennas according to the first and second embodiments have one or more windows formed on the side surfaces thereof. Therefore, it can be found that a wider bandwidth W_{B} is secured than a bandwidth W_{A} which is secured when the window is not provided.

Accordingly, it is possible to implement such a wideband chip antenna that can secure a wide bandwidth.

In the above-described wideband chip antenna according to the present invention, the slot or slit is formed on the top surface, and simultaneously, the slit is formed on the bottom surface. Therefore, the wideband chip antenna can simultaneously transmit and receive signals at various bands, and the size thereof can be reduced.

Further, the widths of the slot and slit can be adjusted so as to easily adjust the resonance property of the antenna, thereby enhancing an antenna gain and radiation efficiency.

Further, the wideband chip antenna has the windows formed on the side surfaces thereof, thereby securing a wider bandwidth.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A wideband chip antenna in which the outer surface of a dielectric or magnetic body block is surrounded by a conductor, the wideband chip antenna comprising:
one or more slots or slits that are formed on the top surface of the wideband chip antenna and of which predetermined portions are opened;
one or more slits that are formed on the bottom surface of the wideband chip antenna and of which predetermined portions are opened; and
one or more windows that are formed on one or more side surfaces of the wideband chip antenna by opening predetermined portions thereof.

2. The wideband chip antenna according to claim 1,
wherein the width of the slot is adjusted so as to have a predetermined value.

3. The wideband chip antenna according to claim 1,
wherein the width of the slit formed on the top surface is adjusted so as to have a predetermined value.

4. The wideband chip antenna according to claim 2,
wherein the width of the slit formed on the bottom surface is adjusted so as to have a predetermined value.

5. The wideband chip antenna according to claim 1,
wherein a one-side width of the slot is adjusted so as to be larger than the other side width of thereof.

6. The wideband chip antenna according to claim 1,
wherein a one-side width of the slit formed on the top surface is adjusted so as to be larger than the other side width of thereof.

7. The wideband chip antenna according to claim 5,
wherein a one-side width of the slit formed on the bottom surface is adjusted so as to be larger than the other side width of thereof.

8. The wideband chip antenna according to claim 5,
wherein the one-side width of the slot is adjusted so that the slot has an isosceles trapezoid shape where a one-side width is larger than the other side width.

9. The wideband chip antenna according to claim 6,
wherein the one-side width of the slit formed on the top surface is adjusted so that the slit has an isosceles trapezoid shape where a one-side width is larger than the other side width.

10. The wideband chip antenna according to claim 8,
wherein the one-side width of the slit formed on the bottom surface is adjusted so that the slit has an isosceles trapezoid shape where a one-side width is larger than the other side width.

11. The wideband chip antenna according to claim 5,
wherein the one-side width of the slot is adjusted so that the slot has a semi-elliptical shape where a one-side width is larger than the other side width.

12. The wideband chip antenna according to claim 6,
wherein the one-side width of the slit formed on the top surface is adjusted so that the slit has a semi-elliptical shape where a one-side width is larger than the other side width.

13. The wideband chip antenna according to claim 11,
wherein the one-side width of the slit formed on the bottom surface is adjusted so that the slit has a semi-elliptical shape where a one-side width is larger than the other side width.
